(19) United States
(12) Patent Application Publication
(10) Pub. No.: US 2015/0056486 A1
(43) Pub. Date: Feb. 26, 2015

(54) CATHODIC MATERIAL, ENERGY STORAGE SYSTEM, AND METHOD

(71) Applicant: General Electric Company, Schenectady, NY (US)

(72) Inventors: Manikandan Ramani, Clifton Park, NY (US); John Thomas Leman, Schenectady, NY (US); Job Thomas Rijssenbeek, Niskayuna, NY (US); Rebecca Suzanne Northey, Delmar, NY (US)

(73) Assignee: General Electric Company, Schenectady, NY (US)

(21) Appl. No.: 13/974,335

(22) Filed: Aug. 23, 2013

(51) Int. Cl. H01M 4/38; H01M 10/36

(52) U.S. Cl. CPC H01M 4/381; H01M 10/36
USPC 429/102; 252/181.7

(57) ABSTRACT

An electrochemical cell is provided that includes a cathode chamber including a cathode material and an ion sequestering material, an anode chamber including a molten alkali metal material and a separator disposed in an ionic conductivity path between the cathode chamber and the anode chamber. The electrochemical cell demonstrates a reduced increase in discharge resistance.

### BACKGROUND

1. Technical Field

The invention includes embodiments related to a cathodic material, an energy storage system, and an associated method.

2. Discussion of Related Art

Metal chloride batteries with a molten sodium anode may be employed for energy storage applications. Such batteries may be charged in a maintenance mode.

Maintenance mode charging may involve a float voltage. Float voltage is when a voltage is continuously applied to battery terminals. The amplitude of that voltage can be above a rest state voltage of the battery when it is fully charged. The purpose of maintenance mode charging may be to maintain the battery in a fully charged condition so that when it is called into service, it will be able to deliver its full capacity.

### BRIEF DESCRIPTION

According to a first embodiment, a cathodic material is provided that includes a cathode material and at least one getter material dispersed therein. Cations of a first type are the main ionic current carrying cations of the device and have a lower affinity for the getter material than cations of a second type. The getter material is selected from beta″-alumina, clay, zeolite, carbon and mixtures thereof.

According to a further embodiment, an energy storage device comprising (a) a first compartment including a molten alkali metal, (b) a second compartment including a cathode composition, and (c) a separator positioned between the first and second compartment is provided. The cathode composition comprises a cathode material and a getter material disposed within said cathode material.

According to an additional embodiment, an electrochemical cell is provided. The cell includes a cathode chamber including a cathode material and an ion sequestering material, an anode chamber including a molten alkali metal material and a separator disposed in an ionic conductivity path between the cathode chamber and the anode chamber. The ion sequestering material forms a barrier region between at least a portion of said cathode material and said separator.

### BRIEF DESCRIPTION OF THE DRAWINGS

These and other features and aspects of the invention may be understood with reference to the accompanying drawings in which like characters represent like parts throughout the drawings, wherein:

FIG. 1 is a schematic view illustrating a front cross-sectional view of an electrochemical cell in accordance with an embodiment of the invention; and

FIG. 2 is a graphical representation of the resistance of variously configured battery cells based on days on a float voltage.

### DETAILED DESCRIPTION

Metal chloride batteries are often maintained on a float voltage to assure the ability to provide full capacity upon demand. A float or maintenance voltage is usually at least 0.05 volt above the rest state voltage of the electrochemical cell. It has been determined that free cations in the electrochemical cell of the battery (often introduced as trace impurities) can be detrimental to the longevity of the battery, particularly when maintained on a float voltage. Moreover, without being bound by theory, it is believed that the trace impurities are drawn into the device separator, leading to an increase in resistance over time.

Sodium metal halide (e.g., sodium nickel chloride) energy storage devices or electrochemical cells (e.g., batteries) can be used in various power usage applications. In one embodiment, an energy storage device is constructed of an electrochemical cell including a housing having an interior surface defining a volume. A separator is disposed in the volume. The separator has a first surface that defines at least a portion of a first compartment, and a second surface that defines at least a portion of a second compartment. The first compartment is in ionic communication with the second compartment through the separator. The first compartment (an anode chamber) includes a metallic alkali metal and the second compartment (a cathode chamber) includes a cathode current collector.

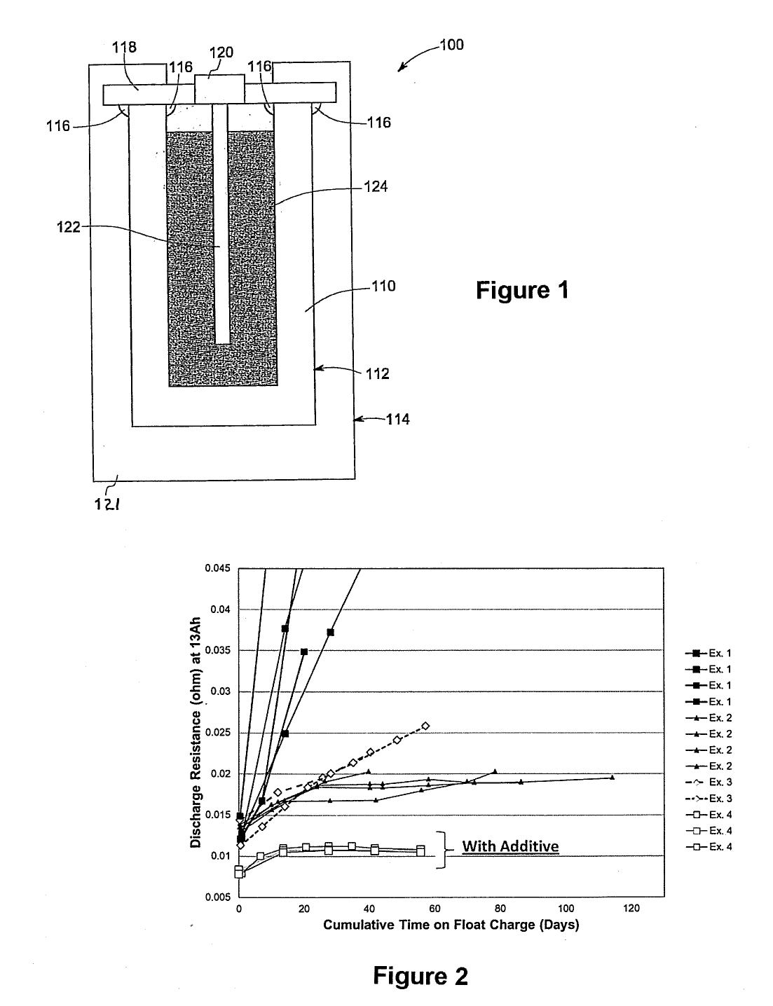

Reference to FIG. 1 depicts a representative electrochemical cell. Electrochemical cell 100 includes separator tube 110 within a housing 114. The tube 110 may be joined by a glass seal 116 to a collar 118. The collar 118 in turn may be joined to a metal collar 120. The tube 110 may be held in position within housing 114 by welding the metal collar 120 to the housing 114. A molten anodic material 121 may be disposed within housing 114. A cathode current collector 122 may be fixed inside the tube 110 and welded to an inner collar (not shown in figure) joined to the tube 110. Cathodic material granules 124 may be loaded into the tube 110 and surround current collector 122.

The housing can be sized and shaped to have a cross-sectional profile that may be polygonal (e.g., square) or rounded (e.g., circular or cloverleaf) to provide maximal surface area for alkali metal ion transport. The housing can be any appropriate size for the desired capacity. The housing can be formed from a material that may be a metal, ceramic, or a composite. The metal can be, for example, nickel or steel, while the ceramic can be a metal oxide.

The first compartment (the anode chamber) can receive and store a reservoir of anodic material that may be transported across the separator between the anode chamber and the cathode chamber. More particularly, the anodic material provides a main ionic carrying cation that passes through the ionic conduction path of the separator and into the cathode chamber. The main ionic material can be an alkali metal. Exemplary main ionic cations include sodium, lithium, and potassium, as well as combinations comprising at least one of the foregoing. The anodic material can be molten during use.

Exemplary additives for use with the anodic material include a metal oxygen scavenger such as manganese, vanadium, zirconium, aluminum, titanium, tantalum, or a combination comprising at least one of the foregoing. Other possible additives include materials that increase wetting of the separator surface by the molten anodic material. Additionally, some additives can enhance the contact or wetting between the separator and the current collector, e.g., to ensure substantially uniform current flow throughout the separator.

The separator can be an alkali metal ion conductor solid electrolyte that conducts alkali metal ions during use between the anode chamber and the cathode chamber. Exemplary separator materials include an alkali-metal-beta-alumina, alkali-metal-beta″-alumina, alkali-metal-beta-gallate, or alkali-metal-beta″-gallate. In one embodiment, the solid separator includes a beta-alumina, a beta″-alumina, or NASICON, as well as combinations comprising at least one of the foregoing.

The crystal structure of the separator can optionally be stabilized by the addition of small amounts of lithium oxide (lithia), magnesium oxide (magnesia), zinc oxide, yttrium oxide (yttria), or similar oxides, as well as combinations comprising at least one of the foregoing. The separator can also include dopant(s).

As noted above, the separator may be disposed within the volume of the housing. The separator can have a cross-sectional profile normal to the axis that may be a circle, an ellipse, a triangle, a square, a rectangle, a cross, a star, or the like. Alternatively, the separator can be substantially planar. A planar configuration (or with a slight curvature) can be useful in a prismatic or button-type battery configuration, where the separator may be domed or dimpled. Similarly, the separator can undulate.

The energy storage device can have current collectors including anode current collectors and cathode current collectors, with the anode current collector(s) in electrical communication with the contents of the anode chamber and the cathode current collector(s) in electrical communication with the contents of the cathode chamber. Exemplary materials for the anode current collector include titanium (Ti), nickel (Ni), copper (Cu), iron (Fe), carbon (C), as well as combinations comprising at least one of the foregoing, such as steel (e.g., stainless steel), nickel coated steel, and so forth.

The cathode current collector can be present in any suitable form, for example, a wire, paddle, sheet, and/or mesh. The cathode current collector can be comprised of at least one metal and at least one salt. An exemplary cathode current collector includes materials such as platinum (Pt), palladium (Pd), gold (Au), nickel (Ni), copper (Cu), carbon (C), molybdenum (Mo), tungsten (W), tantalum (Ta), and titanium (Ti), as well as combinations comprising at least one of the foregoing.

The cathode chamber contains the cathodic material. The cathodic material can exist in elemental form or as a salt, depending on a state of charge. That is, the cathodic material can be present in elemental form and/or salt form, and the ratio of the weight percent of the first cathodic material in elemental form to the weight percent of the salt form can be based on the state of charge. For example, a cathode material can include transition metal(s) or a transition metal salt(s); alkali metal halide(s); salt(s) comprising alkali metal halide(s) and metal halide(s); and metal (poly)sulfide compound(s). More specifically, the cathode metals(s) can include one or more of aluminum, iron, nickel, zinc, copper, chromium, tin, arsenic, vanadium, tantalum, niobium, tungsten, molybdenum, sodium, potassium, lithium, and iron, as well as combinations comprising at least one of the foregoing. Ni may be may be selected as a primary cathode material.

In some embodiments, the cathodic material comprises two cathodic materials, a first cathodic material and a second cathodic material. The first cathodic material can include aluminum, nickel, zinc, copper, chromium, and iron, as well as combinations comprising at least one of the foregoing. The second cathodic material, which may be different from the first cathodic material, can include aluminum, nickel, zinc, copper, chromium, and iron, as well as combinations comprising at least one of the foregoing. Fe may be selected as a secondary cathode material.

In one embodiment, the cathodic material may be used in a powder form. The powder can be granulated to give granules with a uniform mixture to increase packing density. It may be desirable that the powder blend may be closely packed together in a dense manner.

In certain embodiments, small amounts of additional additives may be included to improve the electrochemical cell. In one embodiment, the additives may comprise a metal for example, aluminum; a metal sulfide, for example zinc sulfide, iron sulfide, or iron disulfide; or an alkali metal halide, for example, sodium iodide or sodium fluoride. In certain embodiments, it has been observed the addition of a metal sulfide or sulfur to the cathode prevents or minimized the growth in size of the nickel particles on cycling. This arrests or minimizes the decrease in the surface area and the associated decrease in the capacity of the electrochemical cell. In addition, iodide and fluoride may assist in stabilizing the resistance of the cell.

In one embodiment, the electrochemical cell can also be provided with a getter material selected to bind unwanted contaminants. As used herein, the term getter material can alternatively be referred to as an ion exchange material. Moreover, depending upon the purity of the materials used in manufacture of the cathodic material and/or the current collectors, and/or the housing, the electrochemical cell can contain levels of cations that do not contribute to the function of the cell. These cations can include, for example, cations of alkali metals, alkali earth metals, rare earth metals and transition metals. Specific examples may include one or more of Li, Mg, K, Ca, Cu, Zn, Rb, Sr, Cd, Cs, Ba, Hg and Pb.

The separator may be vulnerable to impurity ions that can cause high resistance and loss of cell performance. Contaminant ions may infiltrate the separator and degrade the separators' ability to efficiently perform the desired conduction of alkali metal ions between the anode and cathode chambers.

For example, the presence of barium ions in the separator may cause a commensurate increase in the resistivity of a beta″-alumina separator. The movement of the cations into the separator seems to occur both via chemical means and electrochemical means. This exchange can happen during cycling but may be aggravated during maintenance charging.

According to one embodiment, an additive that pre-emptively sequesters contaminant ions away from the separator can be provided. This additive may be referred to herein as a getter, i.e., a sacrificial material provided to sequester contaminant ions away from the separator. Moreover, a sacrificial material in the cathode granules and/or in the intra-granular matrix can sequester the harmful cations. Without being bound by theory, the getter function can be driven by thermodynamic forces (enthalpic or entropic) and/or ionically in the case of a monolithic getter distribution between the cathode and the separator. Accordingly, the impact of the free cations may be distributed throughout the cathode volume, and/or remote from the cathode current collector, thereby reducing or minimizing ohmic loss at the cathode/separator interface.

Exemplary getter materials include beta″-alumina, clay, zeolite, carbon, layered metal oxides, sulfides, phosphates, or a combination thereof. Examples of suitable clays can include montmorillonite (devoid of water may be desireable), potentially intermixed with chlorite, muscovite, illite, cooeite, and/or kaolinite. Examples of suitable zeolites can include Na-ZSM-5, sodium conducting alumino-silicates, and/or sodium zeolite-A. Examples of carbon inclusive materials include carbon black, soft and hard carbon materials (partially graphitized to amorphous) and optionally treated to remove volatiles such that an increase in bar pressure is less than 0.1 bar at 400 degrees C.

The getter material can be distributed uniformly throughout the cathode material. Alternatively, the getter material may be distributed in a defined manner. For example, in some embodiments, the getter material may be distributed along a gradient. In the device of FIG. 1, that gradient could be a horizontal gradient, wherein the highest loading of the getter occurs nearest the separator tube 110 and the lowest loading of the getter occurs nearest the cathode current collector 122. Alternatively, the getter material may be disposed so as to form a concentric tube lying parallel to the elongated walls of separator tube 110 as seen in FIG. 1. The getter tube may be located closer to the separator tube 110 than the cathode current collector 122. In this manner, a plurality of contaminant ions present in the cathode material may pass through or near the getter tube before reaching the separator.

The getter material can have a particle size in a range of from less than about 5 micrometers, from about 5 micrometers to about 10 micrometers, from about 10 micrometers to about 15 micrometers, from about 15 micrometers to about 25 micrometers, or from about 25 micrometers to about 1000 micrometers. An exemplary D50 for the granular getter material may be around about 20 micrometers. In one embodiment, the D50 may be in a range of from about 10 micrometers to about 20 micrometers, from about 20 micrometers to about 30 micrometers, or greater than about 30 micrometers. For example, the cathode material can include beta″-alumina having a minimum surface area of at least about 2.0×10⁻⁴ m²/g.

The percentage of getter material to cathode material may be between about 0.001% and 25% by weight. In one embodiment, the percentage of getter material to cathode material may be in the ranges of from about 0.001% to about 1%, from about 1% to about 5%, from about 5% to about 10%, from about 10% to about 25%, or greater than about 25%. In one embodiment, the getter material may be present at about 2% by weight of the combined cathode composition. A weight ratio of getter material to cathode material may be in a range of from about 0.005:1 to about 0.25:1.

The total amount of getter material present in the electrochemical cell may have a surface area greater than the total surface area of the cathode side of the separator. The surface area of the getter material may be at least 10× the surface area of the cathode side of the separator. In one embodiment, the surface area of the getter material may be in the ranges of from about 1× to about 2×, from about 2× to about 5×, from about 5× to about 10×, or greater than about 10× of the surface area of the cathode side of the separator. The specific surface area may be calculated using standard mathematical calculation, absorption, or gas permeability techniques. Although these techniques may yield divergent results, since the present disclosure relies on the ratio between the getter material and the surface area of the separator exposed to the cathode side of the cell satisfactory results may be obtained using either technique provided the same technique may be used for each side of the ratio.

According to one embodiment, the getter may be dispersed in the cathode material. For example, the getter may be randomly dispersed throughout the interstitial spaces in the granular cathode material. Alternatively, the getter may be applied to the surface of the granular cathode material or dispersed within the pores of the granular cathode material.

A combined getter-cathode material may be prepared by sizing the getter material to the appropriate dimension, combining the desired amount of getter material with the cathode materials, granulating the combined getter and cathode materials, and loading the granulated particles into the cathode chamber of an electrochemical cell. In an alternative embodiment, the getter material may be introduced as a molten salt slurry composition or through melt suspension.

As a further example, the cathode composition can be formed by combining an ion sequestering material with the cathode composition by one of granulation, extra-granular inclusion by agitation, slurry in a cathode melt, and spray drying. The ion sequestering material can be added to the cathode material as at least one of granules, a melt, or as a porous layer. The ion sequestering material can be ground as part of the cathode material. The ion exchange material can be dispersed between granules of the cathode material. The ion exchange material may be advantageously calcined or heat treated prior incorporation into the cathode material. If beta″-alumina is used suitable temperatures may be in a range of greater than 200 degrees Celsius.

### EXAMPLES 1-6

Electrochemical cells are prepared and evaluated. In particular, cells are formed by drying NaCl in an oven at 240° C. under vacuum and milling the dried salt to a particle size of approximately 90%<75 um. Thereafter, the milled salt is combined with the remaining cell constituents set forth in the following Table (expressed in weight percent, except barium which is expressed in parts per million), granulated, sieved and using a fraction 0.325-1.5 mm formed into cells, of the type depicted in FIG. 1.

261522-1

TABLE

| | | | | | beta″- | | | |
|---|---|---|---|---|---|---|---|---|
| Example | Ni | NaCl | Al | ZnS | Al₂O₃ | Ba | NaI | NaF |
| 1 (x3) | 60 | 35 | .4 | 2.5 | 2 | 600 ppm | | |
| 2 (x2) | 60 | 35 | .4 | 2.5 | — | 600 ppm | | |
| 3 | 60 | 35 | .4 | 2.5 | — | trace | | |
| 4 (x3) | 60 | 35 | .4 | 2.5 | — | trace | 1.0 | |
| 5 (x2) | 60 | 35 | .4 | 2.5 | — | trace | | 1.5 |
| 6 (x2) | 60 | 35 | .4 | 2.5 | — | trace | 1.0 | 1.5 |

The results of the evaluation on increase in resistance over time on float charge are depicted in the graph of FIG. 2. When beta″-alumina calcined powder is added during granulation of the cathode material, the initial resistance and the rate of increase slows down when the cells were floated at 2.75 V and 295° C. for a prolonged duration.

### EXAMPLES 7-12

Electrochemical cells are prepared and evaluated. In particular, cells are formed by drying NaCl in an oven at 240° C. under vacuum and milling the dried salt to a particle size of approximately 90%<75 um. Thereafter, the milled salt is combined with the remaining cell constituents set forth in the above Table (expressed in weight percent, except barium which is expressed in parts per million), granulated, sieved and using a fraction 0.325-1.5 mm formed into cells, of the type depicted in FIG. 1. However, in one cell montmorillonite will replace the beta″-alumina, in one cell Na-ZSM-5 zeolite will replace the beta″-alumina, and in one cell carbon black will replace the beta″-alumina.

### EXAMPLE 13

An electrochemical cell is constructed to include a beta″-alumina tube surrounding the cathode. The tube is positioned within the cathodic material of the cell. The tube can be positioned relatively closer to the electrochemical cell separator than to the cell's cathode current collector. The beta″-alumina tube is constructed by a method including the steps of:

(A) mixing about 80 to about 95 weight percent of powdered beta″- Al₂O₃ with about 5 to 15 weight percent of binder, such as polyvinyl alcohol,
(B) adding a 50%/50% distilled water-isopropyl alcohol solution in drop wise additions to the mixture to form a stiff dough (the solution will constitute about 40 to about 60 weight percent of the formed dough),
(C) forming the dough into a tube preform and sintering the preform at about 1200° C. for about one hour under vacuum, and
(D) cooling under vacuum to ambient temperature.

### EXAMPLE 14

An electrochemical cell is constructed to include a dispersion of beta″-alumina in the cathodic material surrounding the cathode current collector. The dispersion is arranged such that a barrier concentration of beta″-alumina is disposed between a major portion of the cathodic material and the cathode current collector. The barrier concentration is not a continuous such as the tube of Example 13, but rather, is a dispersion of beta″-alumina within the cathodic material. The dispersion will have a relative concentration of beta″-alumina in the cathodic material that will increase in the direction of the separator. Accordingly, the dispersion will have a highest concentration of beta″-alumina at a side closest to the anode and a lowest concentration of beta″-alumina at a side closest to the cathode.

Scavenging impurities that harm the separator via the getter enables improved float voltage tolerance and/or enables the use of lower purity raw materials that contain, for example, high barium and/or high calcium impurities. For example, the getter inclusive electrochemical cell can demonstrate an increase in resistance that is at least about 50% lower compared to a cathode not prepared in accord with this disclosure. The getter also makes the cell more robust to higher voltage charging. Charging at higher voltages enables faster recharge. The tolerance at higher voltages can reduce the number of cells required for a particular application.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A cathodic material, comprising:
a cathode material and at least one getter material, wherein cations of a first type are comprised of the main ionic current carrying cation and have a lower affinity for the getter material than cations of a second type, said getter material being selected from beta″-alumina, clay, zeolite, carbon and mixtures thereof.

2. The material of claim 1, wherein said cations of the first type comprise Na ions.

3. The material of claim 2, wherein cations of the second type are selected from the group consisting of cations of alkali metals, alkali earth metals, rare earth metals, transition metals and combinations thereof.

4. The material of claim 1, wherein said getter material is distributed uniformly throughout the cathode material.

5. The material of claim 4, wherein said getter material occupies interstitial spaces within the cathode material.

6. The material of claim 1, wherein said getter material is distributed along a gradient.

7. The material of claim 1, wherein said getter material comprises beta″-alumina.

8. The material of claim 1, wherein the getter material has a particle size between about 5 and about 1000 micrometers.

9. The material of claim 1 having a weight ratio of the getter material to the cathode material in the range of about 0.005:1 to about 0.25:1.

10. An energy storage device comprising:
a first compartment comprising a molten alkali metal;
a second compartment including a cathode composition; and
a separator positioned between the first and second compartments, wherein said cathode composition comprises a cathode material and a getter material, said getter material being disposed within said cathode material.

11. The energy storage device of claim 10, wherein the weight ratio of the getter material to the cathode material is in the range of 0.005:1 to 0.25:1.

12. The energy storage device of claim 10, wherein the getter material has a total surface area greater than a surface area of a cathode side of said separator.

13. The energy storage device of claim 10, wherein said getter material comprises at least about 2% by weight of said cathode composition.

14. The energy storage device of claim 10, wherein the device demonstrates an increase in discharge resistance which is at least 50% lower than an identical energy storage device without the getter material when each energy storage device is maintained continuously at an elevated float voltage for 50 days.

15. The energy storage device of claim 10, wherein said getter material is distributed in a gradient.

16. The energy storage device of claim 15, wherein said getter material gradient comprises a relatively higher concentration closer to the separator than to a cathode current collector.

17. The energy storage device of claim 10, wherein said getter material comprises beta″-alumina.

18. The energy storage device of claim 10, wherein the cathode material is selected from the group consisting of Ni, Fe, Cr, Al, Zn, Cu, Cr, Sn, As, V, Ta, Nb, W, Mo, Na, K, Li, and mixtures thereof.

19. An energy storage device comprising:
a first compartment comprising metallic alkali metal; and
a second compartment comprising a cathode composition, said cathode composition comprising a cathode material and an ion sequestering material, wherein a separator is disposed in an ionic conductivity path between the first and second compartments, said ion exchange material forming a barrier region between at least a portion of said cathode material and said separator.

20. The energy storage device of claim 19, wherein said barrier region is disposed relatively closer to the separator than a cathode current collector.

21. The energy storage device of claim 20, wherein said barrier region comprises a tube.
